(19) United States
(12) Patent Application Publication
(10) Pub. No.: US 2025/0130972 A1
(43) Pub. Date: Apr. 24, 2025

(54) OVERLAYS FOR SOFTWARE AND HARDWARE VERIFICATION

(71) Applicant: VIRGINIA COMMONWEALTH UNIVERSITY, Richmond, VA (US)

(72) Inventors: Carl Elks, Richmond, VA (US); Richard Hite, Richmond, VA (US); Christopher Deloglos, Richmond, VA (US); Smitha Gautham, Richmond, VA (US); Athira Jayakumar, Richmond, VA (US); Abhilash Devalapura Rajagopala, Richmond, VA (US); Thomas Monroe Gibson, Richmond, VA (US)

(21) Appl. No.: 18/553,093

(22) PCT Filed: Mar. 30, 2022
(86) PCT No.: PCT/US2022/071432

§ 371 Date: Sep. 28, 2023

Related U.S. Application Data
(60) Provisional application No. 63/169,630, filed on Apr. 1, 2021.

(51) Int. Cl. G06F 15/78

(52) U.S. Cl. CPC G06F 15/7867; G06F 15/7896

(57) ABSTRACT

Disclosed are various approaches for updating a processor, such as a field programmable gate array (FPGA), to execute in a verifiable manner without having to reprogram or reconfigure the processor after initial configuration. A sequence of values describing an order of execution for a plurality of function blocks within a task lane that represents a task is generated. Then, a list of operation codes and register locations for inputs and outputs of each function block in the task lane is generated. Next, a sequence of function blocks for the task lane based at least in part on the sequence of values and the list of operation codes and register locations is generated. Then, the sequence of function blocks is stored in a memory of the processor. Finally, the sequence of values and the list of operation codes and register locations can be executed with the processor.

### CROSS-REFERENCE TO RELATED APPLICATIONS

This application claims priority to, and the benefit of, U.S. Provisional Patent Application 63/169,630, entitled “FPGA OVERLAYS FOR SOFTWARE AND HARDWARE VERIFICATION,” which was filed on Apr. 1, 2021 and is incorporated by reference as if set forth herein in its entirety.

### BACKGROUND

Complexity significantly impedes confidence and trust placed in the design and operation of safety critical systems. Complexity is not a goal of engineering. It emerges as a consequence of the increasing sophistication of technology. These trends challenge safety verification and certification processes as it is difficult to guarantee at design time that system errors (or hazards) are prevented or controlled in such a way that there will be no unreasonable risk associated with the system during operation.

For example, in virtually all fields of endeavor that employ electronic devices for safety critical or related applications, there is a high standard of testing, verification, and validation of the safety related electronic devices to ensure the devices do not introduce unknown or unanticipated failures during operation. These high standards for verification and testing can be burdensome in terms of cost and time (labor hours). At present, it is not uncommon for testing and verification to consume 80% of the overall project budget for safety critical systems.

### BRIEF DESCRIPTION OF THE DRAWINGS

FIGS. 1-7 depict many aspects of the present disclosure. The components in the drawings are not necessarily to scale, with emphasis instead being placed upon clearly illustrating the principles of the disclosure. Moreover, in the drawings, like reference numerals designate corresponding parts throughout the several views.

### SUMMARY

Various embodiments of the present disclosure involve a system that includes a computing device comprising a memory and a processor, such as a field programmable gate array (FPGA). The processor can include: at least one task lane comprising a function block array and at least one local sequencer configured to provide linear sequencing of operations performed by individual function blocks in the function block array; and a global sequencer communicatively coupled to the at least one task lane, the global sequencer being configured to output to the at least one task lane a vector of independent and ordered signals. In some implementations, the processor is further configured to validate an input data type for each input to each function block in the function block array. In some implementations, the processor is further configured to validate operations of each function block in the function block array to detect value overflow or value underflow in an operation of each function block. In some implementations, the function block is one of a pair of function blocks configured to operate in duplex, and the processor is further configured to: compare a first value generated by a first function block in the pair of function blocks with a second value generated by a second function block in the pair of function blocks; and report an error in response to a determination that the first value fails to match the second value. In some implementations, the at least one task lane is one of a plurality of task lanes that can be executed by the processor in parallel.

Various embodiments of the present disclosure involve a method for programming a processor, such as a field programmable gate array (FGPA), which includes generating a sequence of values describing an order of execution for a plurality of function blocks within a task lane that represents a task; generating a list of operation codes and register locations for inputs and outputs of each function block in the task lane; generating a sequence of function blocks for the task lane based at least in part on the sequence of values and the list of operation codes and register locations; storing the sequence of function blocks in a memory of the processor; and executing, with the processor, the sequence of values and the list of operation codes and register locations. In some implementations, the method further includes generating, for the task represented by the task lane, a graph that encodes the dependencies between each function block by converting the inports, outports, function blocks and connections between the inports, outports, and function blocks into a directed acyclic graph (DAG). In some implementations, the task lane is one of a plurality of task lanes that can be executed by the processor in parallel.

### DETAILED DESCRIPTION

A major challenge before safety critical systems designers and stakeholders is to construct systems that operate reliably and safely despite complexity, and to do so in a tractable and cost-effective manner. This is particularly important for Cyber-Physical Systems (CPS). Cyber-Physical Systems include multiple coordinating and cooperating components, which are often software-intensive, sometimes with autonomous functionality, interacting with each other, and with the physical world. As Cyber-Physical Systems are used in a number of safety critical applications, their complexity and functionality are on the rise. These trends challenge verification processes, as it is problematic to make strong assurances at design time that system errors are prevented or controlled in such a way that there will be no unreasonable risk associated with the system during operation.

One of the fundamental heuristic guidelines in system design is to keep the system architecture as simple as possible. In general, a less complex design is a better design. The basic idea is that the simpler the system is, the easier it is to design, verify, implement, and maintain. However, cutting-edge computing systems are becoming more complex than ever due to the ever-increasing complexity of new technologies and ecosystems to support them. This is becoming more evident in today's embedded computing systems and Cyber-Physical Systems technology. New, embedded computing technology, especially software and IP-based, is allowing almost unlimited configurability and extensibility in modern systems. It is estimated that software verification and certification can consume up to 85 percent of the total project budget in some application domains. Perhaps the greatest impact of complexity with respect to critical systems is that it gradually erodes the confidence in the design of these systems. Highly integrated systems can be susceptible to cascading failures, which can lead to accidents or incidents with unintended consequences.

The causes of these systematic failures are very often traced back to poorly understood interdependencies between computer systems, software, and humans (or autonomy) that result in unexpected and unknown failure modes from the physical and computing relationships. A major contributing factor in these systematic failures is the lack of awareness of the complexity that is manifesting in critical systems. Without principles, models, and methods to manage system architecture complexity at design time, the system's overall complexity may become unwieldy, leading to unanticipated behaviors, such as hazard/loss scenarios, and lack of confidence in safety assurance. Approaches that address these problems are referred to as complexity-aware solutions.

The concept of complexity has been studied broadly in a variety of disciplines such as computer science, systems engineering, and information theory. Each discipline adopted different approaches for characterizing and studying complexity in systems. To manage complexity in embedded systems or CPSs, one needs to understand the different types of complexity that can arise. Complexity has two main perspectives—object complexity and cognitive complexity.

Object complexity considers complexity as a property of something while cognitive complexity considers complexity as a relation between something and an observer who tries to understand that thing. Object complexity relates to the architecture of a system and, therefore, represents complexity determined by its form. Given a set of basic functions, there are multiple forms (or architectures) that can perform a specified set of functions.

The second type of complexity follows the observation that complexity can also be subjective, conditioned on the object complexity. It follows that a factor that differentiates complex systems from other systems is intellectual manageability. That is, complex systems have a broad tendency to be challenging to comprehend along multiple dimensions. Accordingly, various embodiments of the present disclosure tend to focus on managing types of object complexity—that is complexity that is most closely related to the architecture of the system. However, there are many types or classifications of complexity in general and object complexity in particular.

Interactive complexity arises in the interactions among system components. In interactively complex systems, accidents may arise in the interactions among components where none of the individual components may have failed. These component interaction accidents result from system design errors that are not caught before the system is fielded.

Non-linear complexity exists when cause and effect are not related in any obvious (or at least known) way. Non-linear complexity is sometimes called systemic complexity” to refer to situations where characteristics indirectly impact all or many of the system components. Examples of systemic factors are management pressure to increase productivity or reduce expenses, which results in safety degradation.

Dynamic complexity is related to understanding changes over time. Systems are not static, especially with extensible programmable systems. Moreover, how people interact with systems changes over time as they learn short-cuts to operational procedures, and bypass certain safety features.

Decomposition complexity is related to how we partition a system into functional components. Decompositional complexity arises when the structural decomposition of the system is not consistent with the function decomposition. Decompositional complexity makes it harder for designers and assessors to predict and understand system behavior. Safety is related to the functional behavior of the system and its components; it is not a function of the system structure or architecture. Decompositional complexity can make it harder for humans to understand and find functional design errors.

Composition or modularity complexity is related to how systems are built from well-formed building blocks or modules that follow from a decomposition process. Modularity is an important property of a system where it represents the degree to which a system can or should be divided into several strategic groups called modules.

Various embodiments of the present disclosure address the challenges of certifying highly safety-critical embedded systems and CPSs in a cost-effective manner. Accordingly, various embodiments of the present disclosure include a number of design decisions to address the following complexity-aware principles discussed in the following paragraphs.

Hierarchy: Hierarchies are often used and cited as a principal means to manage decomposition complexity and improve comprehension. That said, just having levels of abstraction in an architecture does not imply a reduction in system complexity; a poorly designed hierarchy may increase complexity. The type of hierarchy organization and how it is implemented can have a significant impact on V&V effort. Accordingly, a well-formed multi-level can provide a blueprint for the integration of different levels of the system, where each level is governed by a design model. The models at each level of the hierarchy represent and explain functional and structural aspects of the system.

In various embodiments of the present disclosure, a formal hierarchy is employed as opposed to a holonic hierarchy type. A hierarchy is a formal hierarchy if there are no interactions among the modules at the sub-levels of the hierarchy, such as if the modules only relate to the whole of the macro-levels of the hierarchy. A formal hierarchy is the simplest form of a hierarchy since there are no module-to-module interactions among the parts at the lower levels. In theory, each level of a formal hierarchy can be investigated or reasoned in isolation from the other levels. In addition, a formal hierarchy supports composition of modularity of the components. Composability is a desired characteristic of an architecture because it supports the orderly integration of the components to achieve a purpose.

Principle of Separation of Concerns or Partitioning: This principle helps manage complexity by disentangling functions that are separable in order that they can be grouped in self-contained modules or architectural functions. In various embodiments of the present disclosure, space and time partitioning are used to implement separation of concerns. An example principle used is that every critical requirement should be assigned to an independent top-level component that implements only this essential requirement and nothing else. The top-level components implementing critical requirements should be decoupled to the greatest extent possible from each other. Importantly, this principle is implementable in a formal hierarchy structure. An example of time partitioning is the Principle of Sequentiality. This principle recommends that complex concurrent and simultaneous behaviors should be decomposed, wherever possible, into a serial or sequential behavioral structure such that a sequential model of computation or step-by-step analysis of the behavior becomes possible. Each step requires only the investigation of the limited context that is of relevant at this step. In various embodiments of the present disclosure, the sequential model of computation is adopted and behavior in the form of a synchronous time-triggered approach. That is, all execution steps occur at well-defined points in time.

Principle of a Consistent Time and Determinism: The progression of real-time is an important factor in any behavioral model of the physical systems that embedded systems interact with. This principle is crucial in developing deterministic predictable behavior. Consistent time allows agreement and consensus of events by different actors and components in a distributed system. A “state-based” system (or entity) is said to be deterministic if when identical inputs are presented to the system with corresponding state conditions then the system always produces the same identical outputs within a bounded time (and skew).

Principle of Orthogonality: Orthogonality refers to the way a set of basic modules or buildings blocks can be combined in a relatively small number of ways to build the control and data structures of that module. An example of this is LEGO® toy blocks-they can only interact in a few, restricted ways. However, surprisingly complex structures can be built from them. With orthogonality, only required interactions are allowed. The architecture precludes (to the largest extent possible) unwanted interactions and unwanted or unknown hidden coupling or dependencies. Orthogonality ideas can also be applied in execution semantics, where execution is consistent and deterministic across various elements of the architecture.

Principle of Modularity: This principle of modularity follows from principles of decomposition, partitioning, and separation of concerns. A module encapsulates a function or set of functions related to a system requirement. Modularity often abstracts away or hides internal information so that the interfaces of the module completely define the means for a module to deliver service to other modules. Various embodiments of the present disclosure use modularity extensively in the design and implementation of the Function Blocks.

Principle of Independence: Interdependence between modules or architectural units at one level of the hierarchy should be reduced to the necessary minimum. Various embodiments of the present disclosure employ this principle in several places, but most notably in the Task Lanes.

These principles can be used to program or configure processors that operate in a deterministic manner for safety critical systems. Examples of processors can include application-specific integrated circuit (ASIC) or a programmable logic device (PLD). Examples of PLDs include programmable logic arrays (PLAs), programmable array logic (PAL) devices, generic logic arrays (GALs), complex programmable logic devices (CPLDs), field-programmable gate arrays (FPGAs), erasable programmable logic devices (EPLDs), and similar devices.

As an illustrative example, PLD technology such as FGPA FPGA technology could be selected to realize various embodiments of the present disclosure based at least in part on several considerations. First, FPGAs are an increasingly prevalent option for safety critical platforms. Second, in many target applications a hardware-oriented solution is favored over a software-oriented solution. Finally, FGPA technology allows complexity-aware design principles like decomposition, modularity, hierarchy, and independence to map more directly to the synthesis of the various embodiments of the present disclosure.

From a high-level perspective, various embodiments of the present disclosure include an FPGA overlay architecture. Generally, an overlay is an abstraction method that presents a different logical view on the resources of a computer system or architecture than the physically accurate view. The overlay architecture serves two purposes. First, it encodes complexity principles at the architecture level to enhance verifiability and constrain behavior. Second, it employs a model of computation.

The last influence on various embodiments of the present disclosure are model-based engineering and design assurance. Model-based design is a process and method to achieve a complexity-aware design. Model-based engineering (MBE) is about elevating models in the engineering process to a central and governing role in the specification, design, integration, validation, certification, and operation of a system. Executable models support the design, analysis, and verification activities of various embodiments of the present disclosure. In model-based design environments like MathWorks® Simulink®, an initial executable graphical model represents the software or hardware component under development by including appropriate design details while ignoring the details of the underlying software implementation. The model is then assessed by simulation and testing and then refined until it is sufficiently complete to serve as the design to a deployable implementation through automatic code generation. Furthermore, the ability to impose complexity-aware design rules on the models is a significant advantage towards the realization of the various embodiments of the present disclosure.

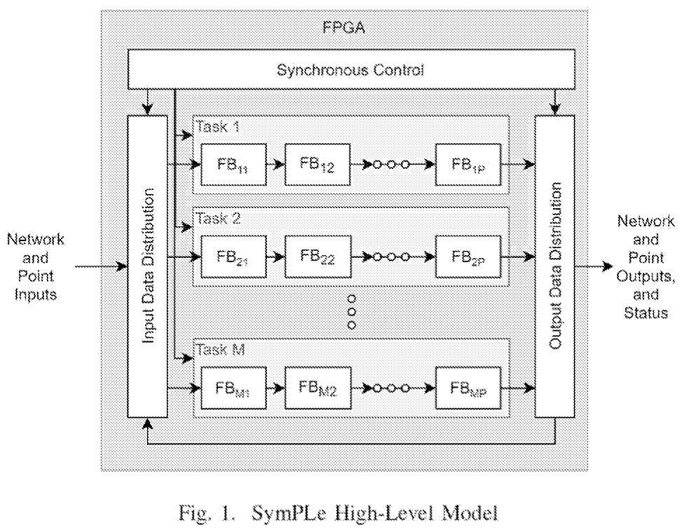

FIG. 1 depicts a high-level representation of an overlay architecture according to various embodiments of the present disclosure. This figure depicts the various embodiments of the present disclosure from a data flow perspective. Here, the synchronous sequential model of computation for a reactive system is adopted. A reactive system has a state which describes (1) the current and past conditions of object that is being controlled or monitored, (2) environmental stimulus (e.g., sensor measurements or other hardware or software inputs) which causes transitions from one state to another state in the control or processing algorithm, and (3) reactions to transitions (output commands) that dictate proper specified behavior to the object.

The second model that can be adopted is a schedule model. A schedule model describes how the executions are organized in relation to a set of applications or tasks. A pragmatic requirement on the models of computation is that the elements of computation be represented as Function Blocks (FBs). The architecture of the Function Blocks will be described later.

The schedule model is reflected in task lanes, where task lanes provide execution stations for statically scheduled application tasks. Application tasks are built up from FBs, much like is done in Programmable Logic Controllers (PLCs). A Function Block is a basic computational unit and is a primitive level of computation in the various embodiments of the present disclosure. An example of a function block could include an International Electrotechnical Commission (IEC) 61131-3 standard compliant function block.

The function blocks available in a particular implementation can be limited to a previously verified library of function blocks. These pre-verified function blocks would have known, verifiable outputs for respective inputs and have been previously formally verified for behavior and execution. As a result, each function block can only perform an operation in predefined manner. Moreover, the semantics of the individual function blocks constrain the ways in which function blocks can be used together within a task lane, allowing for formal verification of the logic of a program represented by a task lane to be easily performed.

Task lanes may be grouped together to form a complete application. The composability of FBs to build tasks to form an application leverages the principles of modularity. This composition of independent tasks with each task including a set of FBs is depicted in FIG. 1. In this figure M refers to the number of tasks instantiated in a given overlay variant, and P refers to the number of Function Blocks in a set of Function Blocks in a task lane.

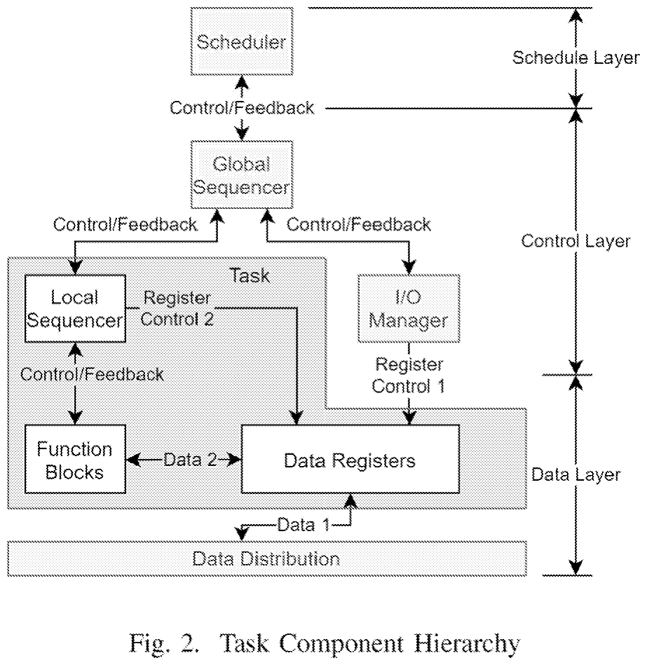

A more refined view of the various embodiments of the present disclosure is shown in FIG. 2. In this figure, three basic hierarchies are depicted: the Global Sequencer, Local Sequencers, and Task Lanes where a set of Function Blocks per task lane are shown. As noted above, all executions occur in task lanes. The Global Sequencer is mostly concerned with scheduling of task lanes and the marshaling of data I/O in the architecture. The Local Sequencer's function is to locally coordinate the triggering of a task lane and marshal data to Function Blocks while executing. The principle of partitioning is used in task lanes to enforce both separation of time and space. Outputs from a task lane are for a given scan cycle and are distinct in time as only one output(s) per scan cycle is possible. Separation of space is implemented in the task lane in that there is no resource sharing between task lanes and no hidden lines of communication.

The Scheduler controls the timed execution of the scan cycle of the architecture. Its output is a bit vector where each bit indicates whether a connected task is to be executed on a given scan cycle execution. Each task is independently scheduled.

The Global Sequencer (GS) provides synchronous control of the scan cycle. When triggered by the Scheduler, the GS's output is a vector of independent and ordered signals that trigger the architecture to read, execute, and write, in that order, on every scan cycle.

The I/O Manager is responsible for marshaling data from/to sources/destinations in the architecture. The set of I/O sources and destinations include point, networked, and Task I/O.

A task is an abstraction of a set of components: a Local Sequencer (LS), a set of Function Blocks (FBs), and a Data Register. The components of a task and an abstraction of their interfaces is depicted in FIG. 2.

The Local Sequencer is the controlling entity of a task lane and is responsible for the linear sequencing of individual FBs and the control of the task registers for communication of data between individual FBs. Accordingly, for a given sequence of function blocks specified for a task lane, the respective local sequencer can control the movement of data from one function block within the task lane to the next function block, including the order of the function blocks through which data flows.

The concern of the Data Registers is the storage of data for communication between individual Function Blocks and from Tasks to other areas of the architecture.

A common flaw in safety critical systems is observed when different tasks utilize shared resources in unexpected ways. Therefore, the application of the principle of separation of concerns between the low-level components of the Function Block architecture is critical. As seen in FIG. 2, each task lane can be instantiated with its own complete Function Block array which can observe a one-to-one mapping between the local sequencer of that task lane and its own instantiated Function Block array. This eliminates the possibility for unexpected crossover between task lanes.

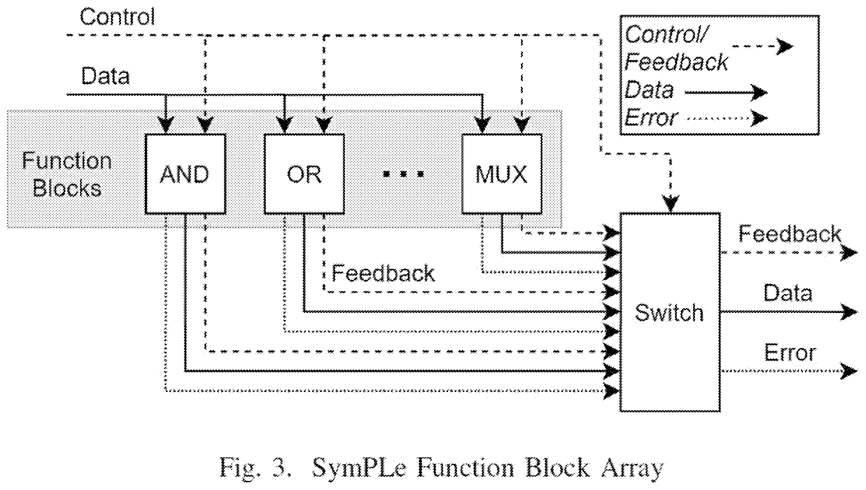

The Function Block array is composed as an array of all defined Function Blocks, as seen in FIG. 3. The design of the Function Blocks eliminates interactive complexity and enforces the principle of separation of concerns as only a single Function Block can ever be active at a given moment in time, and the deactivation of a Function Block requires a complete clear of the Function Block internals.

Every instantiation of the Function Block array is done with the full set of Function blocks, even though a task may only require a subset of functionalities for a given application. This design decision increases the verifiability of the application by eliminating the dependence of the Function Block array architecture on the sequence of a particular task lane.

In developing the Function Blocks, it may be desirable to implement a paradigm where the functionality can be modified or expanded with minimal disruption to the system. This is achieved in the Function Blocks through the application of the Principle of Modularity. This technique facilities a low orthogonality Function Block design whereby each Function Block is required to adhere both to a strict architectural interface and to a strict execution command sequence.

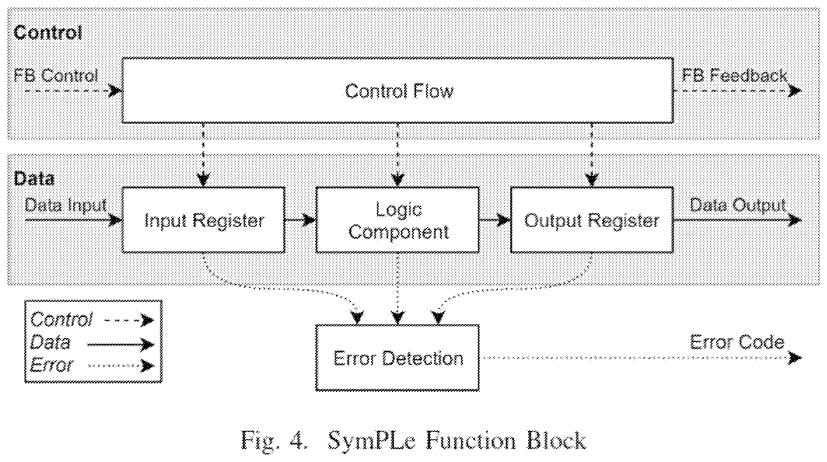

The architectural design of the individual Function Block can be seen in FIG. 4. The Function Block adheres to the read/execute/write cycle both architecturally and in terms of execution sequence. Architecturally, the nature of the Function Block as an FPGA overlay architecture allows partitioning of the data as it progresses through the read, execute, and write components of the architecture, ensuring that intermediary operations in those components do not propagate prematurely.

Various embodiments of the present disclosure define at least four (4) types of data: Boolean, Safe Boolean, Integer, and Qₘₙ. The Boolean type is a single-bit Boolean value. The safe Boolean type is a 32-bit Boolean value consisting of alternating ‘1010 . . . ’ or ‘0101 . . . ’ for True and False, respectively. The integer type is a 32-bit signed integer. The Qₘₙ type is a signed fixed-point value consisting of a 32-bit integer and 24-bit fractional precision using the Qₘₙ standard. These types are applied across 32 Function Blocks with the operations listed in Table I. This array of operators supports the design of a wide variety of applications.

TABLE I
SYMPLE FUNCTION BLOCK TYPES

| Function Block | Description |
|---|---|
| AND, OR, NOT, XOR, NAND, | Logical Operators (Int/Bool) |
| NOR | |
| BAND, BOR, BNOT, BXOR, | Bitwise Logical Operators (Int) |
| BNAND, BNOR, BSL, BSR | |
| MAX, MIN, MUX | Selection Operators (All Types) |
| GT, GE, EQ, LT, LE, NE | Comparison Operators (Int/Qₘₙ) |
| ADD, SUB, MUL, DIV | Arithmetic Operators (Int/Qₘₙ) |
| MOVE | System Operators (All Types) |
| QMNtoINT, INTtoQMN, | Type Conversion |
| BOOLtoSAFEBOOL, | |
| SAFEBOOLtoBOOL | |

While the foremost mechanism of safety comes from achieving a high level of verifiability, various embodiments of the present disclosure also support three different categories of runtime error detection mechanisms at the Function Block level. First, various embodiments of the present disclosure validate the Function Block input data type. Each Function Block is designed to be type-aware, outputting errors if any invalid type is fed into a Function Block. Second, various embodiments of the present disclosure validate the operations of the logic component, reporting any errors observed during the execution such as value overflow and underflow in arithmetic operations. Third, each Function Block is instantiated as duplex, reporting an error if the resulting values of an operation diverge. Application of error detection at the Function Block level allows for fail-stop/fail-fast behavior in the event of a non-recoverable runtime error.

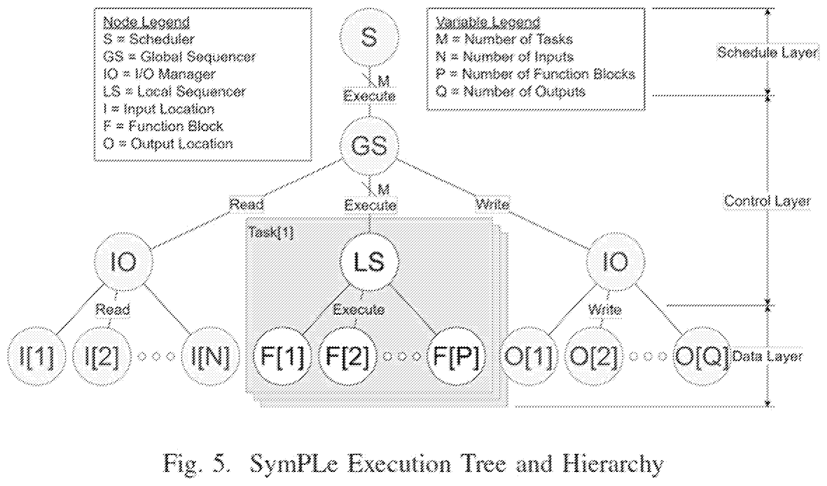

Understanding of execution semantics is aided by the combination of three elements in the architecture: a description of the Separation of Concerns for components, a graphical depiction of the component connections, and an execution algorithm that depicts the ordering of the graphical depiction. The components previously described can be assembled in a functional hierarchy, as shown in FIG. 5. In this execution tree, the nodes represent components of the architecture. Edges of the tree represent control in the downward direction and feedback/acknowledgement in the upward direction. This pattern of control and feedback enforces synchronous deterministic execution behavior of the architecture. The ordering of these components, which could be thought of as a Modified-Depth First Search tree traversal, is described in Algorithm 1. The algorithm uses variables described in FIG. 5 in for loops. Deviation from the algorithm ordering can be an indication of degraded health of the architecture.

Algorithm 1: SymPLe Execution Algorithm

| Input: time, schedule, inputs, function_blocks, outputs | | | | | |
|---|---|---|---|---|---|
| 1 | while true do | | | | |
| 2 | \| | execute_task[all] = false | | | |
| 3 | \| | // Scheduler | | | |
| 4 | \| | while execute_task[all] == false do | | | |
| 5 | \| | \| | forall i ← 1 to M do | | |
| 6 | \| | \| | \| | if time > schedule[i] then | |
| 7 | \| | \| | \|_ | \| | execute_task[i] = true |
| | \| | \|_ | | | |
| 8 | \| | // Global Sequencer triggers read | | | |
| 9 | \| | // I/O Manager reads inputs | | | |
| 10 | \| | forall i ← 1 to N do | | | |
| 11 | \| | \|_ | read(input[i]) | | |
| 12 | \| | // Global Sequencer triggers execute | | | |
| 13 | \| | // Begin parallel task execution | | | |
| 14 | \| | forall i ← 1 to M do | | | |
| 15 | \| | \| | if execute_task[i] then | | |
| 16 | \| | \| | \| | // Local Sequencer[i] executes FBs | |
| 17 | \| | \| | \| | forall j ← 1 to P do | |
| 18 | \| | \| | \| | \|_ | execute_fb(function_blocks[i][j]) |

| | \| | \|_ | \| |
|---|---|---|---|
| 19 | \| | // End parallel Task execution | |
| 20 | \| | // Global Sequencer triggers write | |
| 21 | \| | // I/O Manager writes outputs | |
| 22 | \| | for i ← 1 to Q do | |
| 23 | \| | \|_ | write(outputs[1]) |
| | \|_ | | |

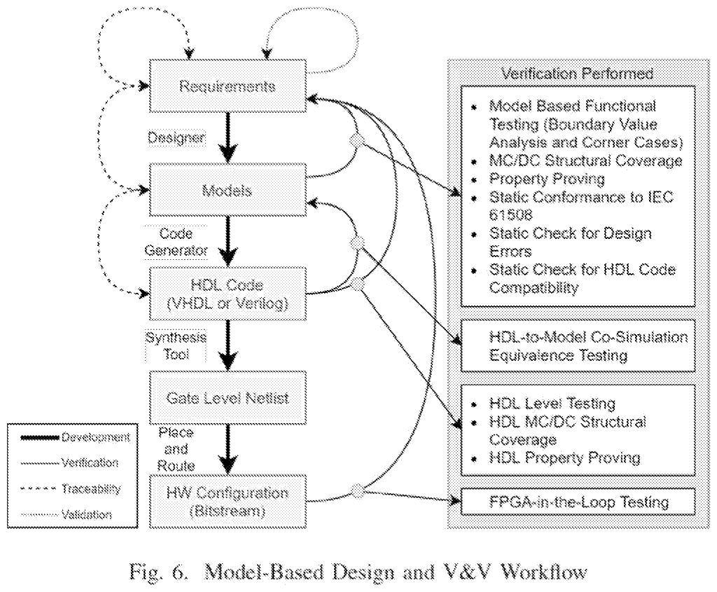

The model-based development process used according to various embodiments of the present disclosure provide a highly verifiable workflow. The workflow in FIG. 6 outlines how the five steps in the workflow relate to each other through development, verification, traceability, and validation.

The design process is a requirements-driven process that references and verifies the designed model throughout the design process. At the beginning of the workflow, a requirements list is created defining what properties the system is required to adhere to. The designer then takes this requirements list and implements the system model, relating each requirement to the part of the model that implements that requirement. Well-defined relationships between the model and the requirements establish a principle of traceability and reduce the decompositional complexity of the model. This requirements-driven design technique also allows for formal verification of the model's compliance to the design requirements using model-based functional testing, Modified Condition/Decision Coverage (MC/DC) structural coverage, property proving, static conformance checks, static design error checks, and static Hardware Description Language (HDL) code compatibility checks.

Once the model is generated and has gone through the verification process, it is compiled to generate HDL code. This HDL code is verified against the model through HDL-to-model co-simulation equivalence testing. The HDL code is also verified against the requirements using the HDL simulation, HDL MC/DC structural coverage, and HDL property proving.

The verified HDL code is synthesized to a gate-level netlist and implemented as a hardware bitstream using a commercial Electronic Design Automation (EDA) tool. One final step of verification is performed using FPGA-in-the-Loop Testing, which allows runtime verification of the requirements.

This workflow employs bi-directional traceability that aids the designers and testers in identifying places where missing requirements are the causation of design faults early in the workflow life-cycle. These types of design workflows are typically required for highly critical systems. However, implementing these workflows is non-trivial.

Certain limitations were identified with this workflow. Model-based development for FPGA architectures is critically dependent on the tools available for synthesizing models down to an FPGA bitstream. As such, models must be designed and implemented exclusively using HDL code generation compliant library blocks which were a subset of the blocks available for other purpose. For example, in the MathWorks® Simulink® design tool, bi-directional buses and tri-state buffers were unable to be designed due to restrictions imposed by the platform language.

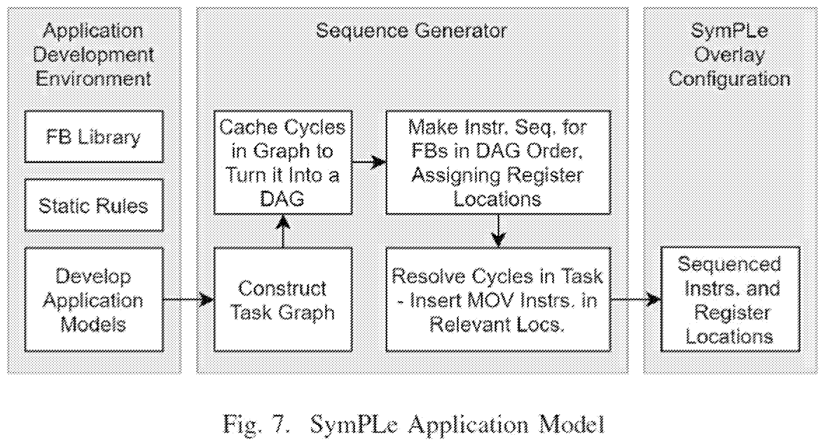

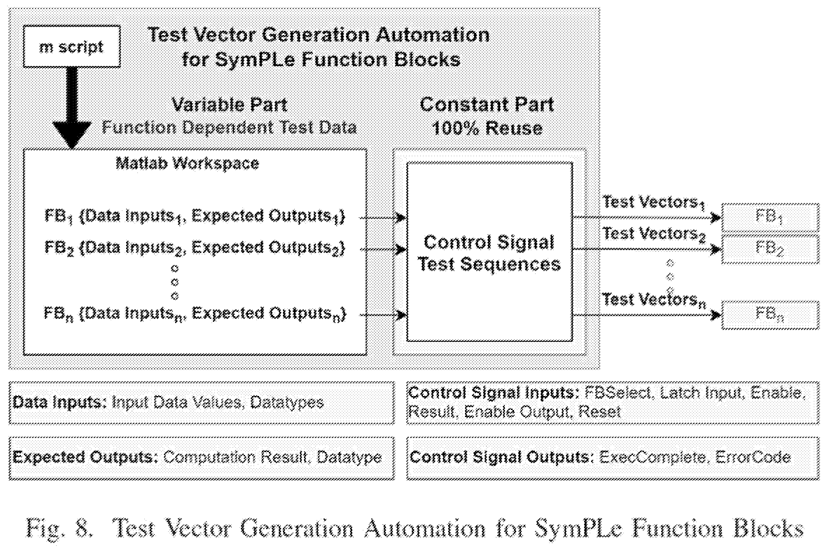

Application programming of the overlay can be done in various embodiments of the present disclosure using a graphical user interface (GUI) embedded in or a component of a design tool, such as the MathWorks® Simulink® design tool. This is in contrast to how FPGAs are normally programmed via FPGA EDA tools which require users to be knowledgeable in Hardware Description Languages and FPGA synthesis to program an FPGA. Such GUIs can have multiple components, including the development environment and the sequence generator. Ultimately, the output of the GUI is to produce a program execution sequence for the Function Blocks for a given task. A high-level graphical description of the application configuration workflow is shown in FIG. 7. The following paragraphs discuss these components in more detail.

The application development environment includes a pre-verified (formal verification and dynamic testing) Function Block library for the user to develop applications with. In addition to the Function Block library, the environment also enforces a set of static checks specific to the architecture, constraining the ways in which a user can connect Function Blocks. The use of a formally verified library and set of static checks allows the application developer to have justifiable confidence in application functionality for an application mode.

Once an application has been designed, the next step is generating a sequence of values describing the execution order of each function block in the task, as well as the relevant operation codes and register locations for inputs and outputs of each function block in a task. To do this, the Sequence Generator treats each task in an application as a graph and encodes the dependencies between Function blocks by converting the inports, outports, Function Blocks, and connections amongst these items into a Directed Acyclic Graph (DAG) from which ordering can be derived. The output from the Sequence Generator is as sequence for the Function Blocks where each one occurs after each of its predecessors.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

Any flowcharts or sequence diagrams shown depict the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although any flowcharts or sequence diagrams shown depict a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts or sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g, storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X, Y, or Z). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a memory and a processor; and
wherein the processor comprises:
at least one task lane comprising a function block array and at least one local sequencer configured to provide linear sequencing of operations performed by individual function blocks in the function block array; and
a global sequencer communicatively coupled to the at least one task lane, the global sequencer being configured to output to the at least one task lane a vector of independent and ordered signals.

2. The system of claim 1, wherein the processor is further configured to validate an input data type for each input to each function block in the function block array.

3. The system of claim 1, wherein the processor is further configured to validate operations of each function block in the function block array to detect value overflow or value underflow in an operation of each function block.

4. The system of claim 1, wherein the function block is one of a pair of function blocks configured to operate in duplex, and the processor is further configured to:
compare a first value generated by a first function block in the pair of function blocks with a second value generated by a second function block in the pair of function blocks; and
report an error in response to a determination that the first value fails to match the second value.

5. The system of claim 1, wherein the at least one task lane is one of a plurality of task lanes that can be executed by the processor in parallel.

6. The system of claim 1, wherein the processor is a field programmable gate array (FPGA).

7. A method for programming a processor, comprising:
generating a sequence of values describing an order of execution for a plurality of function blocks within a task lane that represents a task;
generating a list of operation codes and register locations for inputs and outputs of each function block in the task lane;
generating a sequence of function blocks for the task lane based at least in part on the sequence of values and the list of operation codes and register locations;
storing the sequence of function blocks in a memory of the processor; and
executing, with the processor, the sequence of values and the list of operation codes and register locations.

8. The method of claim 7, further comprising:
generating, for the task represented by the task lane, a graph that encodes the dependencies between each function block by converting the inports, outports, function blocks and connections between the inports, outports, and function blocks into a directed acyclic graph (DAG).

9. The method of claim 7, wherein the task lane is one of a plurality of task lanes that can be executed by the processor in parallel.

10. The method of claim 7, wherein the processor is a field programmable gate array (FPGA).
